(19) United States
(12) Patent Application Publication
(10) Pub. No.: US 2006/0159415 A1
(43) Pub. Date: Jul. 20, 2006

(54) System and method for recording and dispensing customized multimedia

(75) Inventors: O'Neil A. McLean, Toronto (CA); Daryl A. Holliday, Toronto (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(73) Assignee: KAIMERA MEDIA INC.

(21) Appl. No.: 11/037,191

(22) Filed: Jan. 19, 2005

(51) Int. Cl. H04N 5/93

(52) U.S. Cl. 386/52

(57) ABSTRACT

There is disclosed a system and method for dispensing customized multimedia. In an embodiment, the system comprises: a media storage module for storing a plurality of recording media, the plurality of recording media each including pre-recorded multimedia content and available recording space for recording customized content; a content capturing module for capturing customized content; a media recording module, operatively connected to the media storage module and the content capturing module, for recording the customized content onto the available recording space of at least one of the plurality of recording media, so as to produce at least one of the customized multimedia; a dispensing module operatively connected to the media recording module for dispensing the customized multimedia.

### BACKGROUND

The present invention relates generally to a system and method for recording and dispensing customized multimedia.

Multimedia is an effective tool for conveying information. The combination of sight, sound, and motion offered by multimedia may be used to deliver a multi-sensory message to a target viewer. Multimedia also offers the ability for a viewer to interact with the content, allowing the viewer, for example, to selectively view only the information that is of particular interest. Furthermore, multimedia may include many different types of content, including interactive teaching tools, product demonstrations, web site links, and more. Developing such multimedia content and the user interface to interact with the content often requires a significant amount of development time and effort. Once developed, the multimedia content may be recorded onto distributable media, such as optical media (e.g. CD-ROMs) or magnetic disk media (e.g. diskettes). The recorded media may then be distributed to a target audience.

While multimedia content may be an effective information delivery tool, getting a target viewer to actually view the multimedia content on the distributed media may be a challenge. In a marketing context, for example, producing and distributing media that is not viewed by a target viewer is a completely wasted effort. What is needed is a cost effective solution for engaging a target viewer so that the target viewer is more likely to view and interact with the multimedia content.

### SUMMARY

The present invention relates to a system and method for recording and dispensing customized multimedia.

In an aspect of the invention, there is provided a system for recording and dispensing customized multimedia, comprising: a media storage module for storing a plurality of recording media, the plurality of recording media each including pre-recorded multimedia content and available recording space for recording customized content; a content capturing module for capturing customized content; a media recording module, operatively connected to the media storage module and the content capturing module, for recording the captured customized content onto the available recording space of at least one of the plurality of recording media, so as to produce at least one of the customized multimedia; a dispensing module operatively connected to the media recording module for dispensing the customized multimedia.

In an embodiment, the recording media is at least one of optical media, magnetic media, and semiconductor media.

In another embodiment, the customized content is at least one of audio content, video content, and photographic content.

In another embodiment, the customized content is configured to be integrated with the pre-recorded multimedia during playback by means of at least one user operable multimedia control.

In another embodiment, the pre-recorded multimedia content comprises promotional content, and the customized content comprises content relating to a target of the promotional content.

In another embodiment, at least one of the plurality of recordable media includes content different from content in another of the plurality of recordable media, so that a user can select from one of a plurality of different themes.

In another embodiment, the system further comprises a media jacket storage module for storing a plurality of media jackets, the media jacket storage module being configured to dispense a media jacket upon dispensing of the customized multimedia.

In another embodiment, the system further comprises a plurality of media jacket storage modules, each media jacket storage module for storing a media jacket corresponding to one of the different themes.

In another aspect of the invention, there is provided a recordable media configured for use in a system for customizing thereof, the recordable media comprising: pre-recorded multimedia content; available recording space for recording customized content; computer readable instructions for integrating the customized content recorded in the available recording space with the pre-recorded multimedia content.

In an embodiment, the recordable media is at least one of optical media, magnetic media, and semiconductor media.

In another embodiment, the customized content is at least one of audio content, video content, and photographic content.

In another embodiment, the pre-recorded multimedia content comprises promotional content, and the customized content comprises content relating to a target of the promotional content.

In another aspect of the invention, there is provided a data processing system implemented method of recording and dispensing customized multimedia, comprising: storing in a media storage module a plurality of recordable media, each of the plurality of recordable media including pre-recorded multimedia content and available recording space for recording customized content; capturing customized content utilizing a content capturing module; recording, utilizing a media recording module, the customized content onto available recording space of at least one of the plurality of recordable media, the media recording module operatively connected to the media storage module, so as to produce the customized multimedia; dispensing the customized multimedia.

In an embodiment, the method further comprises providing for the plurality of recording media at least one of optical media, magnetic media, and semiconductor media.

In another embodiment, the method further comprises capturing for the customized content at least one of audio content, video content, and photographic content.

In another embodiment, the method further comprises providing on the recording media computer readable instructions for integrating the customized content with the pre-recorded multimedia content by means of at least one user operable multimedia control.

In another embodiment, the pre-recorded multimedia content comprises promotional content, and the method further comprises recording customized content relating to a target of the promotional content.

In another embodiment, the method further comprises providing on at least one of the plurality of recordable media content different from content in another of the plurality of recordable media, so that a user can select from one of a plurality of different themes.

In another embodiment, the method further comprising dispensing a media jacket upon dispensing of the customized multimedia.

In another embodiment, the method further comprises providing a plurality of media jacket storage modules, and dispensing a media jacket corresponding to one of the different themes.

These and other aspects of the invention will become apparent from the following more particular descriptions of exemplary embodiments.

### BRIEF DESCRIPTION OF THE DRAWINGS

In the figures which illustrate exemplary embodiments of the invention:

FIG. 1 shows a schematic block diagram of a data processing system which may provide an operating environment for practicing exemplary embodiments of the invention.

FIG. 2A shows a front view of an exemplary recording and dispensing station in accordance with an embodiment of the invention.

FIG. 2B shows a schematic block diagram of various modules that may be contained in the station of FIG. 2A.

FIG. 3 shows a schematic sequence of illustrative screen shots that may appear at the station of FIG. 2A.

FIG. 4 shows a schematic flow chart of a method that may be followed by the data processing system of FIG. 1, corresponding to the sequence of illustrative screen shots in FIG. 3.

### DETAILED DESCRIPTION

As noted, the present invention relates to a system and method for recording and dispensing customized multimedia.

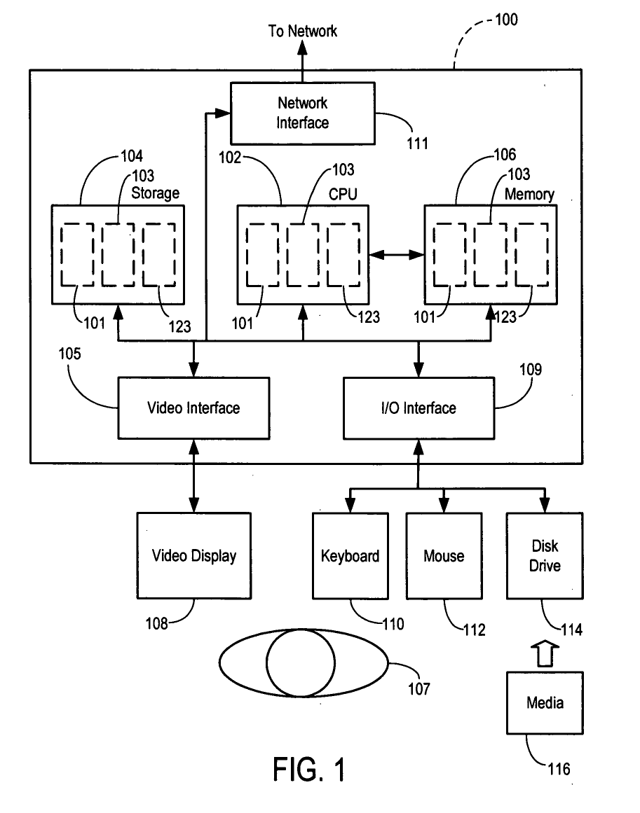

FIG. 1 shows a schematic block diagram of a data processing system which may provide an operating environment for practicing exemplary embodiments of the invention. The data processing system 100 may include a central processing unit (“CPU”) 102 connected to a storage unit 104 and to a random access memory 106. The CPU 102 may process an operating system 101, application software 103, and data 123. The operating system 101, application program 103, and data 123 may be stored in storage unit 104 and loaded into memory 106, as required. A developer 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (“GUI”) controls appearing in the video display 108 with a mouse button. The disk drive 114 may be configured to accept data processing system usable media 116. The data processing system 100 may be network enabled via a network interface 111, allowing the data processing system 100 to communicate with other compatible data processing systems across a network (not shown).

It will be appreciated that the data processing system 100 illustrated in FIG. 1 is merely illustrative, and is not meant to be limiting in terms of the type of system that may provide a suitable operating environment for practicing various embodiments of the present invention.

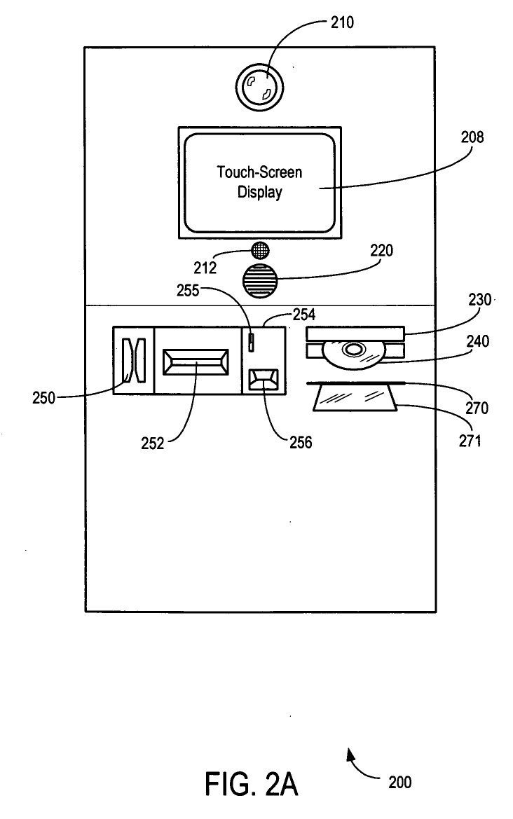

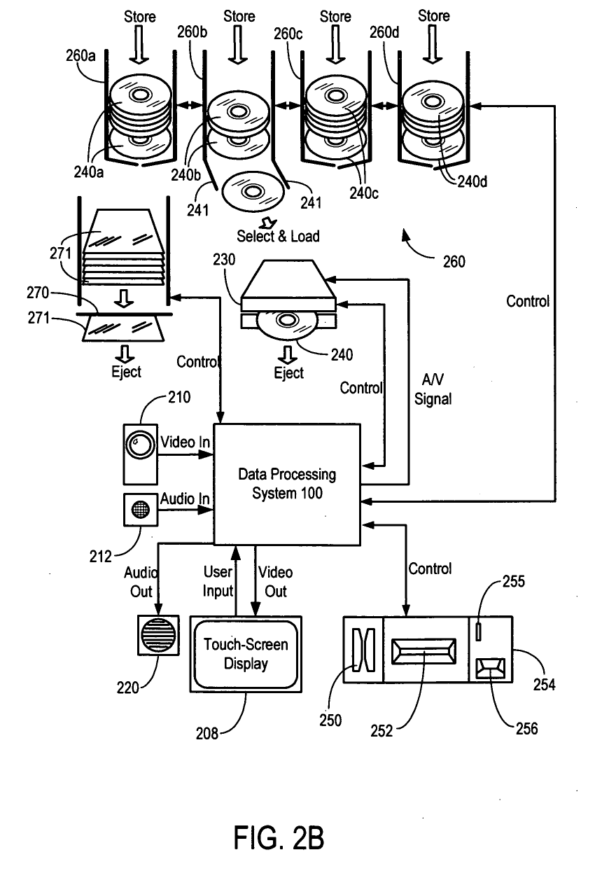

FIG. 2A shows a front view of an exemplary recording and dispensing station 200 in accordance with an embodiment of the invention. FIG. 2B shows a schematic block diagram of various modules that may be contained in the station of FIG. 2A. In the present illustrative embodiment, data processing system 100 may be integrated into station 200, with certain components of the data processing system 100 accessible to a user of station 200.

Referring to FIGS. 2A and 2B, in this illustrative example, video display 108 of data processing system 100 may be fitted with a touch screen overlay to form touch screen display 208. Various other components shown in station 200 may be operatively connected to data processing system 100 by way of cabling, and controllers occupying available I/O expansion slots (e.g. in I/O interface 109 or via other suitable I/O interfaces). These components may include, for example, a content capturing module (e.g. video camera 210 and microphone 212), a speaker 220, a media recording/dispensing module 230 (shown in FIGS. 2A and 2B with an illustrative optical media unit 240 being ejected for pickup), a credit/debit card reader 250, a bill reader 252, and a coin input unit 254 having a coin slot 255 and a coin return slot 256.

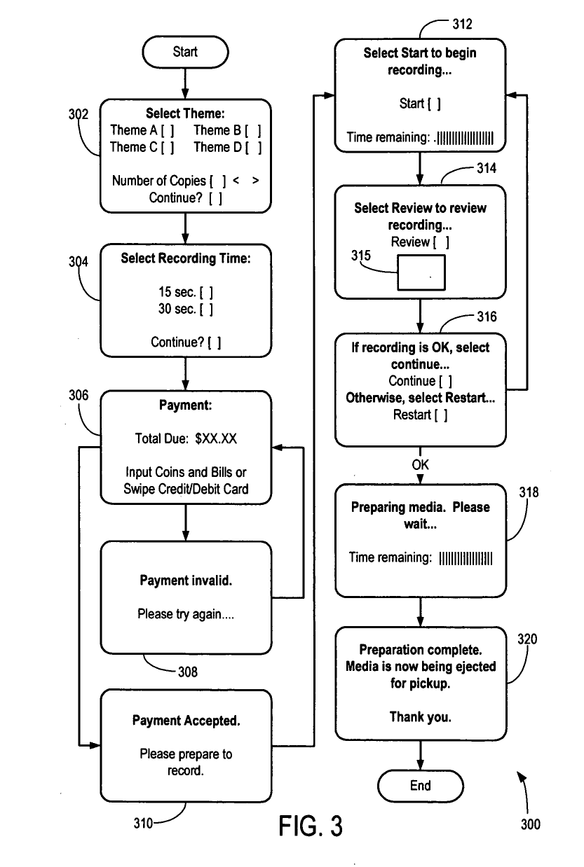

As shown in FIG. 2B, touch screen display 208 may be used to provide instructions to and receive input from a user of station 200. An illustrative example of a sequence of screen shots is discussed with reference to FIG. 3 further below.

Video camera 210 may be any suitable off-the-shelf video unit that may be operatively connected to data processing system 100. Application program 103 running on data processing system 100 may be configured to receive a “video in” signal for recording, for example, into storage 104. Different video recording formats may be used, including any one of a number of industry standard video formats, some of which may provide significant compression of the recorded video signal.

Similarly, microphone 212 may be any suitable off-the-shelf unit that may be operatively connected to data processing system 100. Application program 103 may be configured to configured to operate microphone 212 together with video camera 210 when recording customized multimedia content. Different audio recording formats may be used, including any one of a number of industry standard audio formats, some of which may provide significant compression of the recorded audio signal.

Speakers 220 may be a suitable off-the-shelf unit that may be operatively connected to data processing system 100. Application program 103 may be configured to operate speaker 220 when providing playback of a recording on touch screen 208.

In an alternative embodiment, a voice recognition system may be integrated into station 200 to control various functions. In this case, speaker 220 may be used to provide voice instructions to a user of station 200, and microphone 212 may be configured to receive voice commands from a user of station 200.

The outer portion of media recording/dispensing module 230 is shown in FIG. 2A with an illustrative piece of media 240 being ejected for pickup. In an alternative embodiment, it is possible that a media receiving unit (not shown) may also be provided in station 200 to receive from a user a piece of media 240 for customization at station 200. In this case, changes may be made to provide the user with appropriate instructions for loading and recording customized content.

Presently, the most common type of media for storing multimedia content is optical media, such as various formats of recordable CD, and various formats of recordable DVD. Media 240 may be one of such recordable optical media formats. Alternatively, media recording/dispensing module 230 may be configured to dispense other types of recordable media, such as magnetic media (e.g. diskettes), and semiconductor media (e.g. memory sticks, memory cards).

Credit/debit card reader 250, bill reader 252, and coin input unit 254 having a coin slot 255 and a coin return slot 256 may be operatively connected to data processing system 100 and controlled by a payment subroutine of application program 103 running on data processing system 100. In order to verify a credit card payment, application program 103 running on data processing system 100 may access a credit card verification system via network interface 111. In order to verify a debit card payment, application program 103 running on data processing system 100 may request input of a personal identification number via touch-screen display 208.

Bill reader 252 and coin input unit 254 may have one of any number of conventional designs for such units. However, bill reader 252 and coin input unit 254 must be integrated into data processing system 100 such that sufficient payment can be verified before a user of station 200 can proceed further.

Still referring to FIG. 2B, station 200 may include a plurality of media storage modules 240a-240d for storing recording media. Media storage modules 240a-240d may be operatively connected to data processing system 100 and configured by application program 103 to supply media recording module 240.

In an embodiment, each of media storage modules 240a-240d may store recording media having different pre-recorded multimedia content. This may allow a user of station 200 to select from a number of different themes from a menu displayed at touch-screen display 208. If one of the media storage modules 240a-240d becomes empty, application program 103 may indicate that the corresponding theme is not available at this time. Application program 103 may also be configured to alert, via network interface 111, an off-site location that station 200 requires refills of certain quantities of recording media.

In another embodiment, station 200 may be provided with a media jacket storage module 270 that may store a plurality of media jackets 271. As shown in FIG. 2A, the media jacket 271 may be dispensed from station 200 to the user when the customized recording media 240 is completed and ejected by media recording/dispensing module 230. In an embodiment, blank media jackets may be stored in station 200. In another embodiment, an appropriate graphic design may be printed onto the blank media jackets before being dispensed to the user. In another embodiment, a plurality of media jacket storage modules 270 may be provided, with each media jacket storage module 270 storing a media jacket having a different theme. In this manner, an appropriately themed media jacket may be dispensed.

An illustrative example of a user using station 200 will now be described.

FIG. 3 shows a schematic sequence of illustrative screen shots that may appear at the touch screen display 208 of station 200. By way of example, the first screen 302 that a user may see may provide a menu of possible multimedia themes that the user can select from. In this example, one of four multimedia themes are provided (Theme A to Theme D). Next to each theme may be a touch sensitive area of touch screen display 208 which may indicate a selection of one of the themes by the user. In an embodiment, each theme may be pre-recorded onto recordable media stored in station 200. In this manner, only a small portion of customized content needs to be recorded onto the media to complete the media content. This will be explained in greater detail below.

Below the themes, another input area may be provided to input the number of copies desired. The default number of copies may be one. A pair of controls may be provided so that the user can increase or decrease the number of copies desired. Application program 103 may also be programmed to limit the number of copies that may be selected, so that the copies may be prepared in a reasonable amount of time. It has been determined that a recording time of approximately three minutes per copy or less may be acceptable, although a longer period of time may be acceptable in certain cases. Once the number of copies has been selected at screen 302, another input area may be provided to receive input from the user to continue.

At screen 304, the user may be provided with an option to select a suitable recording time. In the present illustrative example, only a relatively short set recording time of 15 seconds or 30 seconds is provided. Longer or shorter recording times may be provided, depending on the application. Alternatively, a maximum recording time may be provided, so that the user has control over how long the recording time is. Once a suitable recording time has been selected, another input area may be provided to receive an input from the user to continue.

At screen 306, based on the theme, the number of copies, and the recording time selected, the calculated payment may be displayed. As will be appreciated, the payment may be calculated by a subcomponent of application program 103. In this example, screen 306 instructs the user to input coins and bills, or to swipe a credit/debit card. In alternative embodiments, various other methods of payment, such as proximity debit chips, may also be accepted.

Screen 308 shows an exception screen where the payment has not been validated, and the user is instructed to try again. In this illustrative example, assume the user has swiped a credit card that cannot be validated. The user cannot continue further without validation of payment, or payment via another method, such another credit card, a debit card, or bills and coins. If a debit card is used, an appropriate screen (not shown) may appear to allow the user to input a personal identification number.

Screen 310 shows that payment has been validated, and the user is instructed to prepare for recording the customized multimedia content.

If the application is a promotional application that does not require payment, then payment screens 306, 308 and 310 may be bypassed.

Screen 312 shows that station 200 is ready to begin recording upon input of the Start command by the user. A “time remaining” graphic may provide the user with feedback on the amount of time still available for recording. Alternatively, rather than a graphic, this may also be a numeric “countdown”.

In the present illustrative embodiment, when the Start command has been entered, application program 103 running on data processing system 100 may receive a video in signal from video camera 210, an audio in signal from microphone 212, and record the video and audio signals in selected formats onto storage 104. Storing the raw video and audio data on storage 104 will allow the raw data to be further processed before recording onto recording media.

Once the recording has completed, screen 314 provides the user with an opportunity to review the recording. Upon selection of the Review command, the recording may be played back in a window 315 appearing on screen 314. Optionally, the entire screen of touch-screen display 208 may be used during playback. Any recorded sound may be played back through speaker 220 during playback.

Upon completion of playback, screen 316 queries the user whether the recording is OK, or whether the user would like to Restart the recording. If the Restart command is entered, the user is returned to screen 312. If the Continue command is selected, then screen 318 appears.

Screen 318 informs the user that the media is now being prepared (i.e. the customized content is being recorded). Again, a “time remaining” graphic may provide the user with feedback on the process of the preparation of the media.

As the bulk of the multimedia content relating to each theme (Theme A to Theme D in screen 302) is already pre-recorded on media stored in station 200, the time to record the customized multimedia content to complete the multimedia content will be minimal. As noted earlier, the number of copies may be limited to keep the total amount of preparation time reasonable.

Once preparation of the media has been completed, screen 320 informs the user that the prepared media is now being ejected for pickup. Referring back to FIG. 2, media 240 would be ejected from media recording/dispensing module 230 at this time. The recording and dispensing of customized multimedia is now complete.

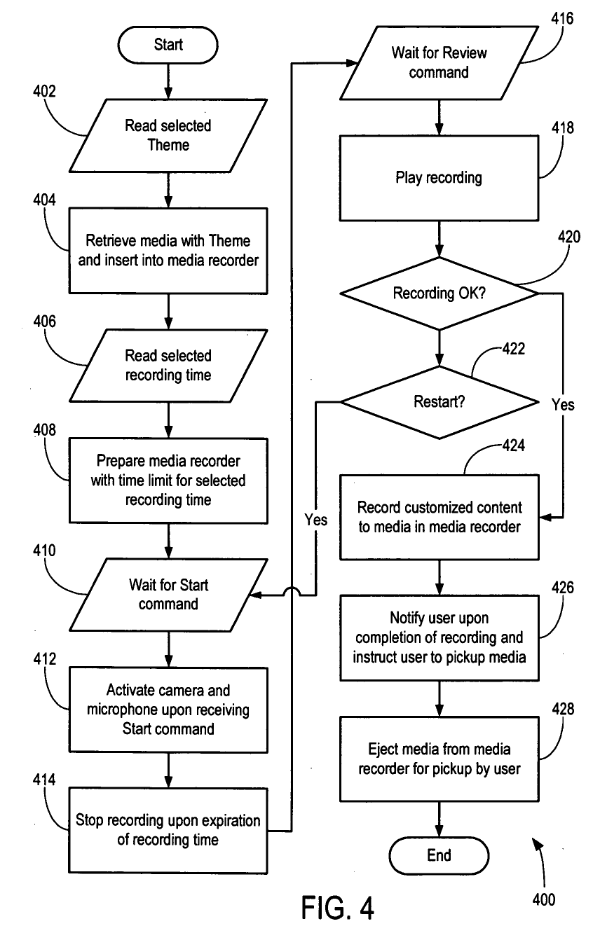

FIG. 4 shows a schematic flow chart of a method that may be followed by the data processing system of FIG. 1, corresponding to the sequence of illustrative screen shots in FIG. 3.

As will be appreciated, application program 103 may be configured to display the contents of each of the screens in FIG. 3 to the user. Application program 103 may be further configured to accept input from the user via touch screen display 208, and to respond to the user input as appropriate. Application program 103 may be further configured to perform method 400 as described below.

At block 402, method 400 the theme (e.g. Theme A to Theme D) selected by the user at screen 302. At block 404, method 400 may control a media storage module (e.g. one of media storage modules 240a-240d) within station 200 to select a recording media pre-recorded with the selected theme. The media is then placed into a media recorder (e.g. media recording/dispensing module 230 of FIG. 2B).

At block 406, method 400 may be configured to read the recording time selected at screen 304.

At block 408, method 400 may prepare the media recorder with the time limit selected by the user.

At block 410, method 400 may wait for the user to input the Start command. Upon this occurrence, method 400 may activate video camera 210 and microphone 212 to begin recording customized multimedia content. In an embodiment, the customized multimedia content may be recorded as data 123 stored in storage unit 104 of FIG. 1.

At block 414, method 400 may be configured to stop video camera 210 and microphone 212 upon expiration of the selected recording time.

At block 416, method 400 may wait for the user to input the Review command.

At block 418, method 400 may playback the recording on touch screen display 208 and speaker 220.

At decision block 420, if method 400 receives input from the user that the recording is OK, method 400 may begin recording of the customized content onto media placed into the media recorder at block 404.

At decision block 422, if method 400 receives input from the user that the user wants to Restart the recording, method 400 may return to block 410.

Once the recording of customized content has been completed at block 424, method 400 may proceed to block 426, where method 400 informs the user that the recording has been completed.

At block 428, method 400 may proceed to eject the prepared media for the user to pickup.

Although one embodiment of a simple recording system has been described and illustrated herein, modifications and variations will be apparent to one skilled in the art. Thus, the scope of the invention is defined by the following claims.

What is claimed is:

1. A system for recording and dispensing customized multimedia, comprising:
a media storage module for storing a plurality of recording media, said plurality of recording media each including pre-recorded multimedia content and available recording space for recording customized content;
a content capturing module for capturing customized content;
a media recording module, operatively connected to said media storage module and said content capturing module, for recording said captured customized content onto said available recording space of at least one of said plurality of recording media, so as to produce at least one of said customized multimedia;
a dispensing module operatively connected to said media recording module for dispensing said customized multimedia.

2. The system of claim 1, wherein said recording media is at least one of optical media, magnetic media, and semiconductor media.

3. The system of claim 2, wherein said customized content is at least one of audio content, video content, and photographic content.

4. The system of claim 3, wherein said customized content is configured to be integrated with said pre-recorded multimedia during playback by means of at least one user operable multimedia control.

5. The system of claim 4, wherein said pre-recorded multimedia content comprises promotional content, and said customized content comprises content relating to a target of said promotional content.

6. The system of claim 1, wherein at least one of said plurality of recordable media includes content different from content in another of said plurality of recordable media, so that a user can select from one of a plurality of different themes.

7. The system of claim 6, further comprising a media jacket storage module for storing a plurality of media jackets, said media jacket storage module being configured to dispense a media jacket upon dispensing of said customized multimedia.

8. The system of claim 7, further comprising a plurality of media jacket storage modules, each media jacket storage module for storing a media jacket corresponding to one of said different themes.

9. Recordable media configured for use in a system for customizing thereof, said recordable media comprising:
pre-recorded multimedia content;
available recording space for recording customized content;
computer readable instructions for integrating said customized content recorded in said available recording space with said pre-recorded multimedia content.

10. The recordable media of claim 9, wherein said recordable media is at least one of optical media, magnetic media, and semiconductor media.

11. The recordable media of claim 10, wherein said customized content is at least one of audio content, video content, and photographic content.

12. The recordable media of claim 11, wherein said pre-recorded multimedia content comprises promotional content, and said customized content comprises content relating to a target of said promotional content.

13. A data processing system implemented method of recording and dispensing customized multimedia, comprising:
storing in a media storage module a plurality of recordable media, each of said plurality of recordable media including pre-recorded multimedia content and available recording space for recording customized content;
capturing customized content utilizing a content capturing module;
recording, utilizing a media recording module, said customized content onto available recording space of at least one of said plurality of recordable media, said media recording module operatively connected to said media storage module, so as to produce said customized multimedia;
dispensing said customized multimedia.

14. The method of claim 13, further comprising providing for said plurality of recording media at least one of optical media, magnetic media, and semiconductor media.

15. The method of claim 13, further comprising capturing for said customized content at least one of audio content, video content, and photographic content.

16. The method of claim 15, further comprising providing on said recording media computer readable instructions for integrating said customized content with said pre-recorded multimedia content by means of at least one user operable multimedia control.

17. The method of claim 16, wherein said pre-recorded multimedia content comprises promotional content, and said method further comprises recording customized content relating to a target of said promotional content.

18. The method of claim 13, further comprising providing on at least one of said plurality of recordable media content different from content in another of said plurality of recordable media, so that a user can select from one of a plurality of different themes.

19. The method of claim 18, further comprising dispensing a media jacket upon dispensing of said customized multimedia.

20. The method of claim 19, further comprising providing a plurality of media jacket storage modules, and dispensing a media jacket corresponding to one of said different themes.
